(19) United States
(12) Patent Application Publication
(10) Pub. No.: US 2025/0285136 A1
(43) Pub. Date: Sep. 11, 2025

(54) TEXT MESSAGES FOR INTERACTING WITH INTEGRATED APPLICATION PROGRAMMING INTERFACES

(71) Applicant: Capital One Services, LLC, McLean, VA (US)

(72) Inventors: Mohamed SECK, Aubrey, TX (US); Judith RODRIGUEZ, Falls Church, VA (US); Danielle BENNINGS, Laurel, MD (US)

(21) Appl. No.: 18/597,522

(22) Filed: Mar. 6, 2024

(51) Int. Cl. G06Q 30/0207; G06F 9/54; G06Q 20/32

(52) U.S. Cl. CPC G06Q 30/0236; G06F 9/547; G06Q 20/326

(57) ABSTRACT

In some implementations, a user device may transmit a first text message that includes a first codeword. Accordingly, the user device may receive an indication of a first confirmation of a first request associated with the first text message. The user device may transmit a second text message that includes a second codeword. Accordingly, the user device may receive an indication of a second confirmation of a second request associated with the second text message.

### BACKGROUND

Many merchants provide application programming interfaces (APIs) for ordering. For example, some merchants may provide mobile applications (also referred to as “apps”) that may be used to access APIs provided by the merchants. In another example, some merchants may provide websites that may be used to access APIs provided by the merchants.

### SUMMARY

Some implementations described herein relate to a system for using text messages with integrated APIs. The system may include one or more memories and one or more processors communicatively coupled to the one or more memories. The one or more processors may be configured to receive a first text message that includes a first codeword. The one or more processors may be configured to transmit a first request to a first API, wherein the first API is selected based on the first codeword, and the first request includes information from the first text message. The one or more processors may be configured to receive, from the first API, a first confirmation of the first request. The one or more processors may be configured to output, to a user device, an indication of the first confirmation. The one or more processors may be configured to provide at least a portion of the first text message to a machine learning model in order to receive a suggested promo code. The one or more processors may be configured to output, to the user device, an indication of the suggested promo code. The one or more processors may be configured to receive a second text message that includes a second codeword. The one or more processors may be configured to transmit a second request to a second API, wherein the second API is selected based on the second codeword, and the second request includes information from the second text message. The one or more processors may be configured to receive, from the second API, a second confirmation of the second request. The one or more processors may be configured to output, to the user device, an indication of the second confirmation.

Some implementations described herein relate to a method of using text messages with integrated APIs. The method may include transmitting, from a user device, a first text message that includes a first codeword. The method may include receiving, at the user device, an indication of a first confirmation of a first request associated with the first text message. The method may include transmitting, from the user device, a second text message that includes a second codeword. The method may include receiving, at the user device, an indication of a second confirmation of a second request associated with the second text message.

Some implementations described herein relate to a non-transitory computer-readable medium that stores a set of instructions for using text messages with integrated APIs. The set of instructions, when executed by one or more processors of a device, may cause the device to receive a first text message that includes a first codeword. The set of instructions, when executed by one or more processors of the device, may cause the device to transmit a first request to a first API, wherein the first API is selected based on the first codeword, and the first request includes information from the first text message. The set of instructions, when executed by one or more processors of the device, may cause the device to receive, from the first API, a first confirmation of the first request. The set of instructions, when executed by one or more processors of the device, may cause the device to output, to a user device, an indication of the first confirmation. The set of instructions, when executed by one or more processors of the device, may cause the device to receive a second text message that includes a second codeword. The set of instructions, when executed by one or more processors of the device, may cause the device to transmit a second request to a second API, wherein the second API is selected based on the second codeword, and the second request includes information from the second text message. The set of instructions, when executed by one or more processors of the device, may cause the device to receive, from the second API, a second confirmation of the second request. The set of instructions, when executed by one or more processors of the device, may cause the device to output, to the user device, an indication of the second confirmation.

### BRIEF DESCRIPTION OF THE DRAWINGS

FIGS. 1A-1K are diagrams of an example implementation relating to text messages for interacting with integrated APIs, in accordance with some embodiments of the present disclosure.

FIG. 2 is a diagram illustrating an example of training and using a machine learning model in connection with systems and/or methods described herein, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of one or more devices of FIG. 3, in accordance with some embodiments of the present disclosure.

FIG. 5 is a flowchart of an example process relating to processing text messages for interacting with integrated APIs, in accordance with some embodiments of the present disclosure.

FIG. 6 is a flowchart of an example process relating to sending text messages for interacting with integrated APIs, in accordance with some embodiments of the present disclosure.

### DETAILED DESCRIPTION

The following detailed description of example implementations refers to the accompanying drawings. The same reference numbers in different drawings may identify the same or similar elements.

APIs may be used to place orders with merchants. For example, a user device may execute an app, associated with a merchant, that communicates with an API provided by the merchant in order to place an order. In another example, a user device may access a website, controlled by a merchant, that communicates with an API provided by the merchant in order to place an order. Executing an app and/or accessing a website consumes power and processing resources at the user device.

Additionally, different merchants may provide different apps and websites. Accordingly, the user device may switch between apps and/or websites in order to order from different merchants. Switching between apps and/or websites increases network overhead, latency, and memory overhead and also consumes additional power and processing resources at the user device.

Some implementations described herein enable a unified system to communicate with APIs provided by different merchants. Therefore, a user device may submit orders to different merchants using the unified system. As a result, the user device reduces network overhead, latency, and memory overhead as compared with switching between apps and/or websites to submit the orders. Additionally, the user device conserves power and processing resources that would otherwise have been spent on switching between apps and/or websites. Some implementations additionally enable the user device to submit orders via text messages. The unified system may therefore communicate with the APIs provided by the merchants based on the text messages. Transmitting text messages conserves power and processing resources at the user device as compared with executing apps and/or accessing websites to communicate with the APIs.

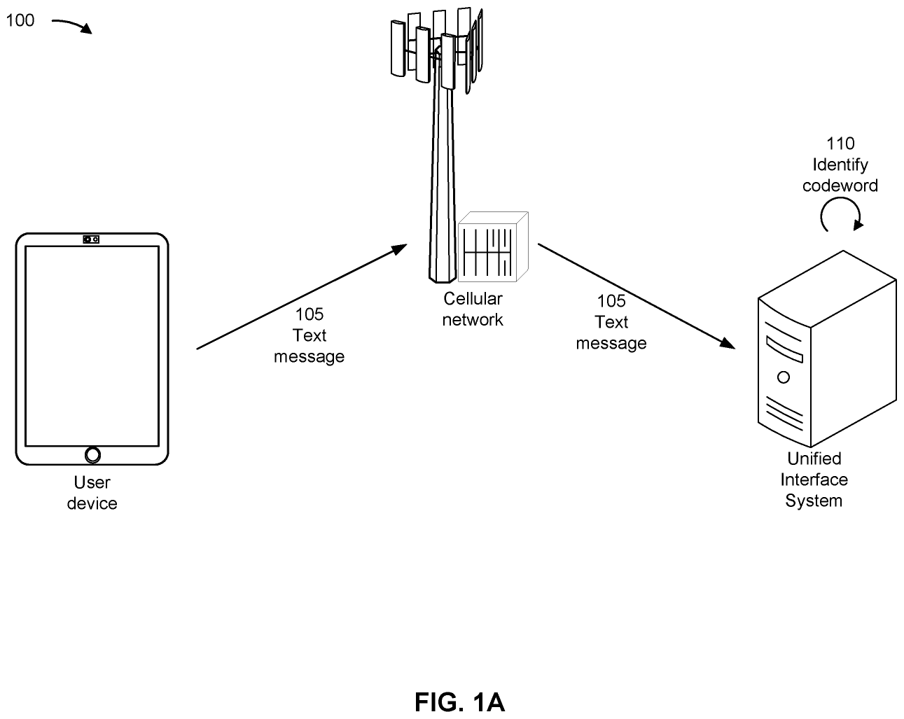

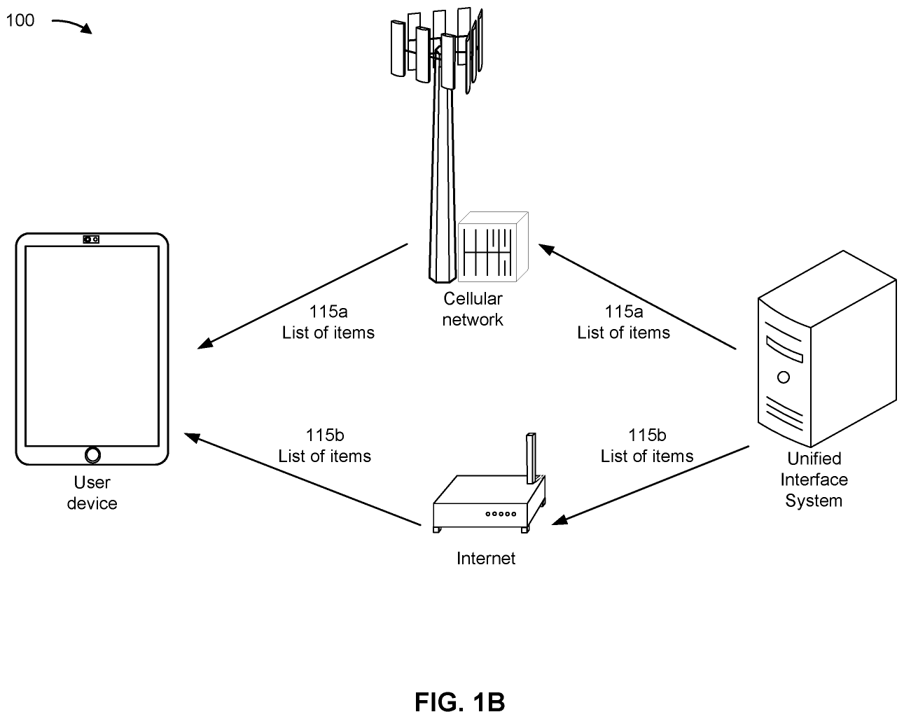

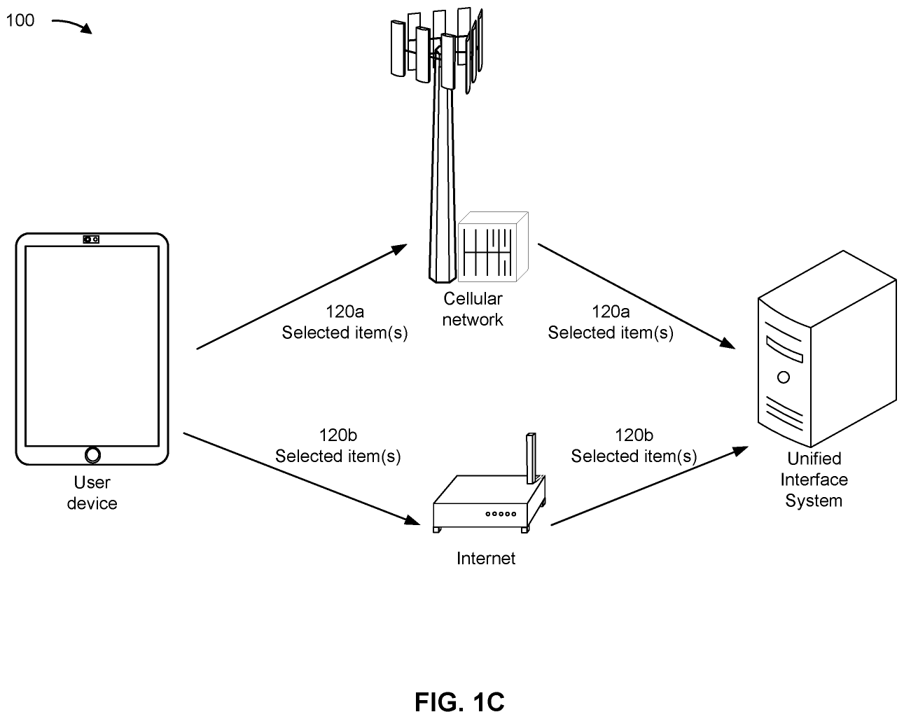

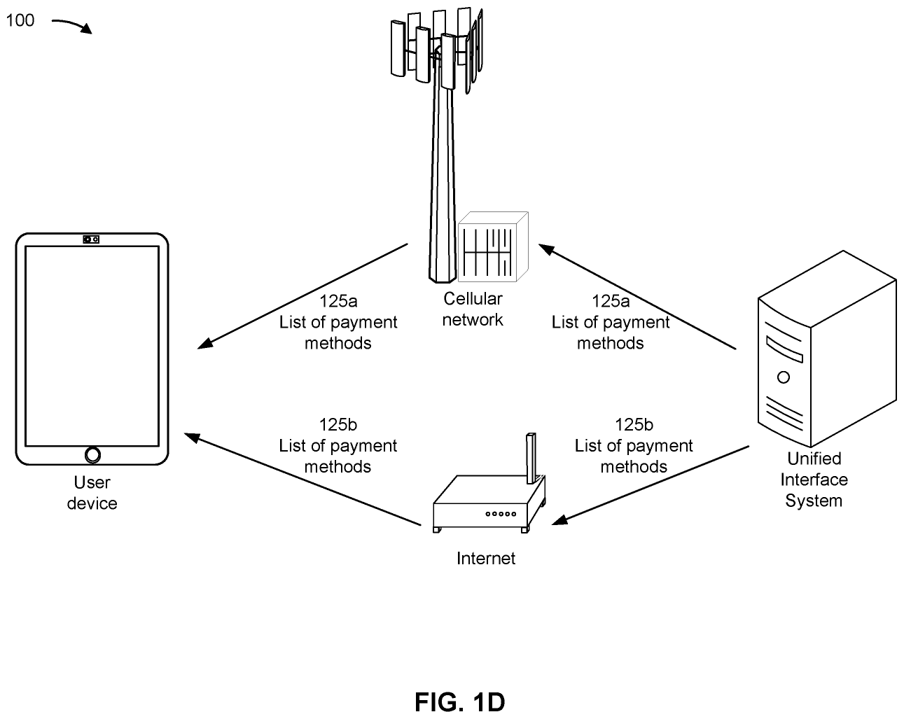

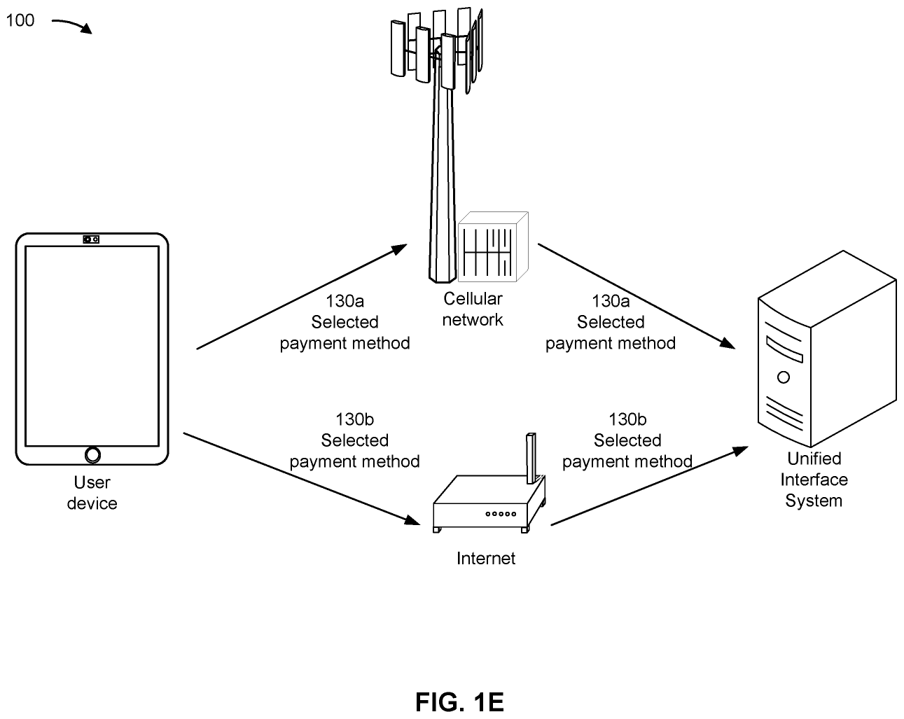

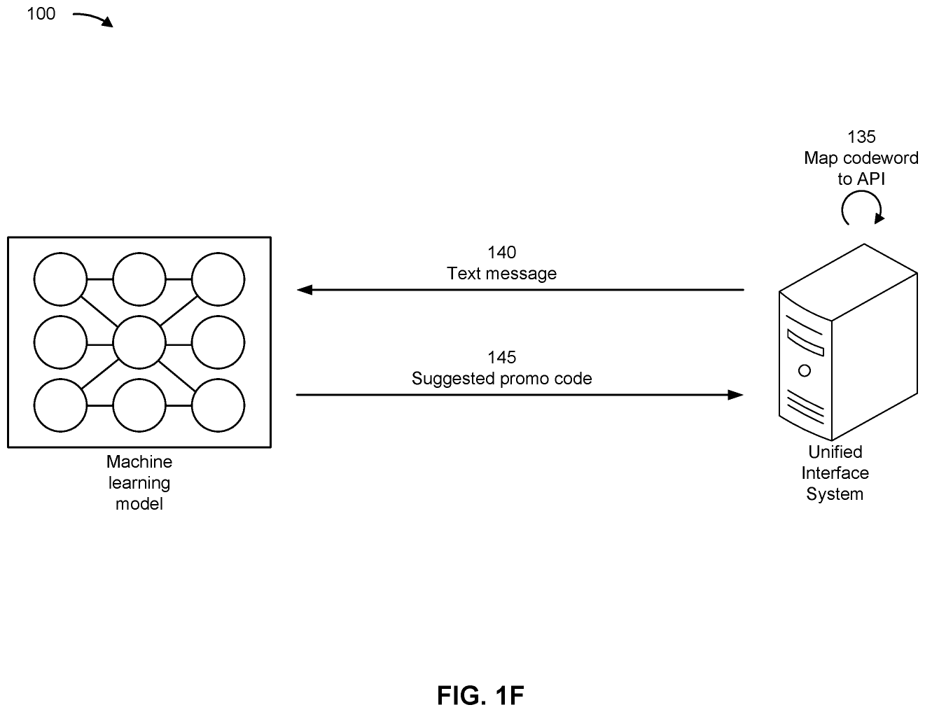

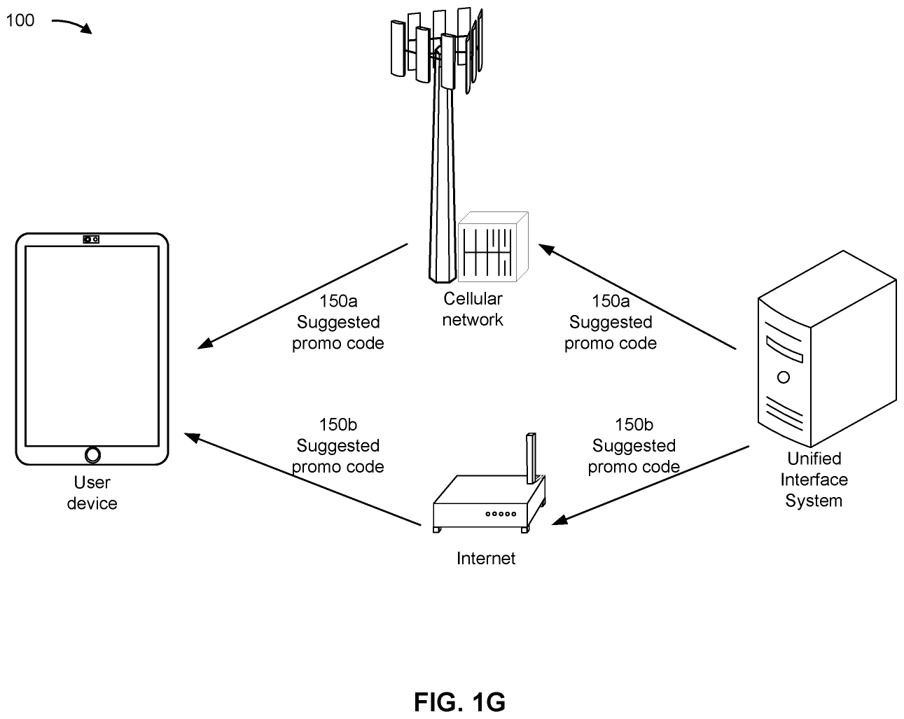

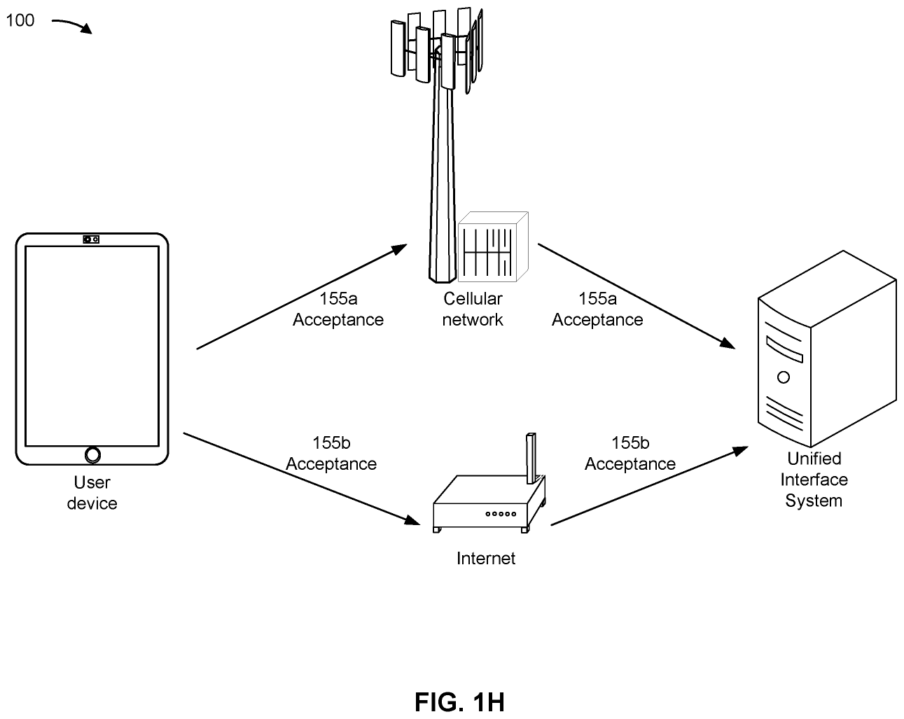

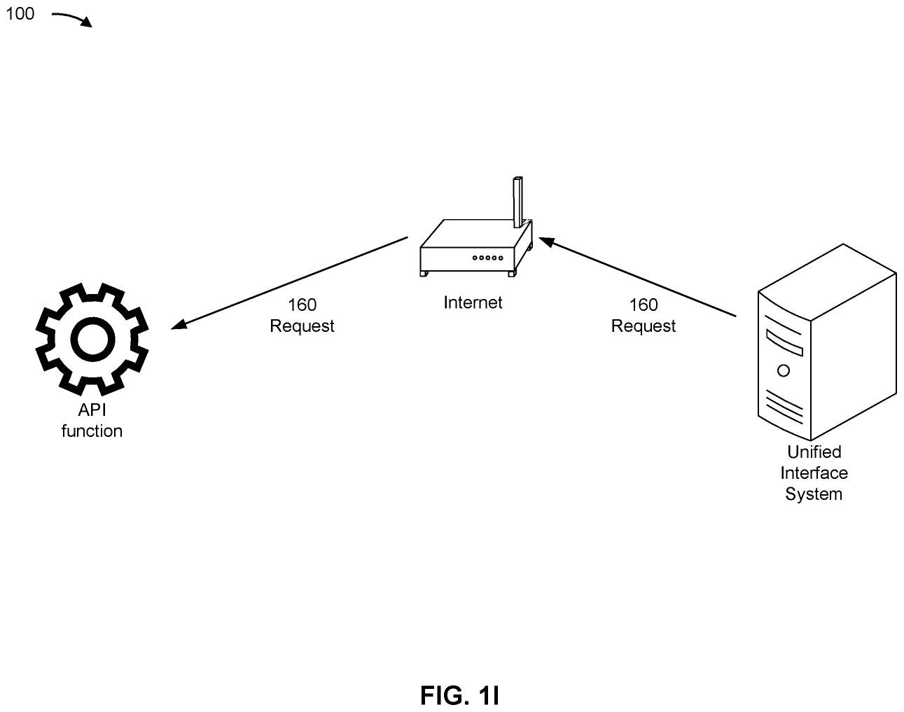

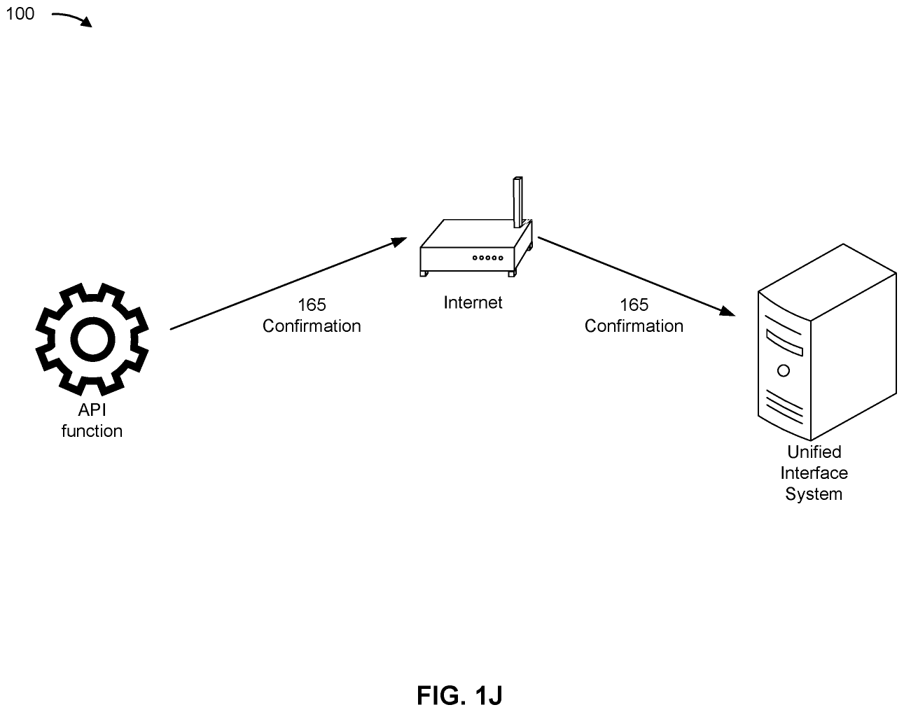

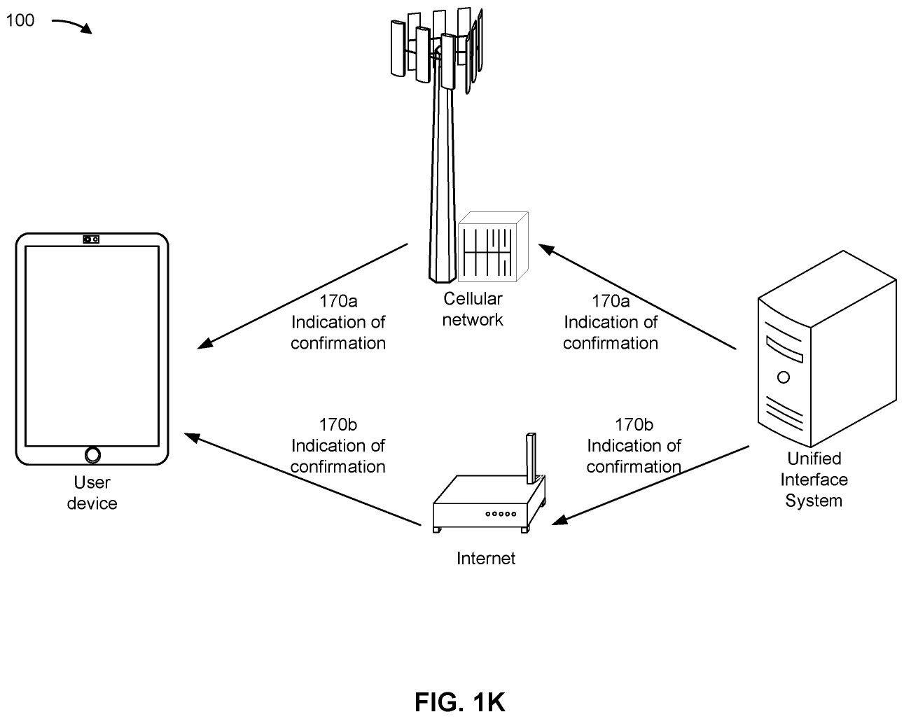

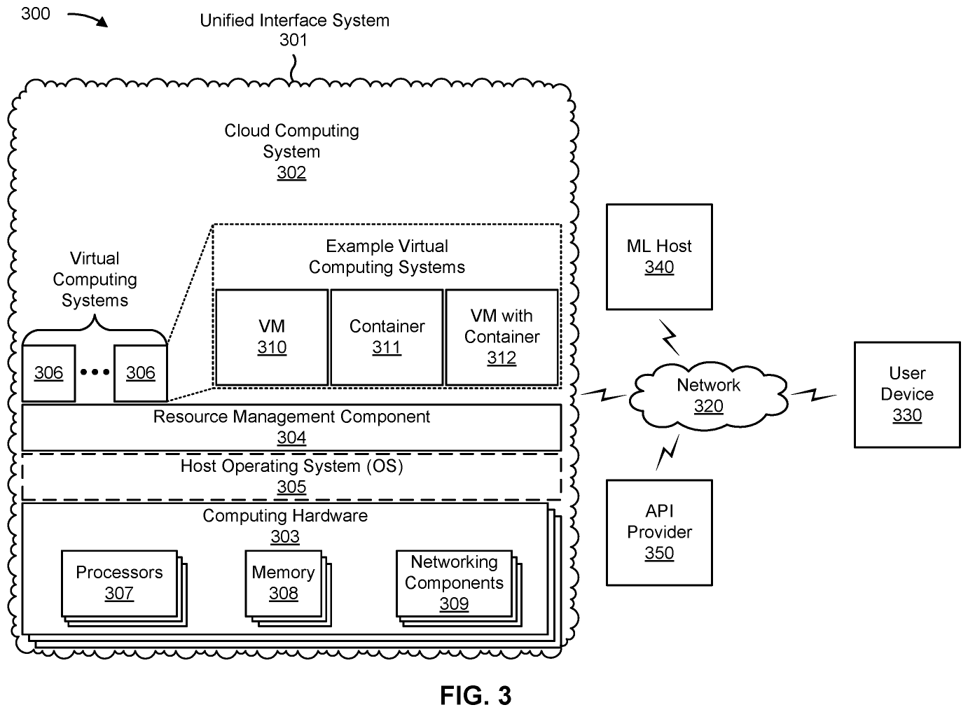

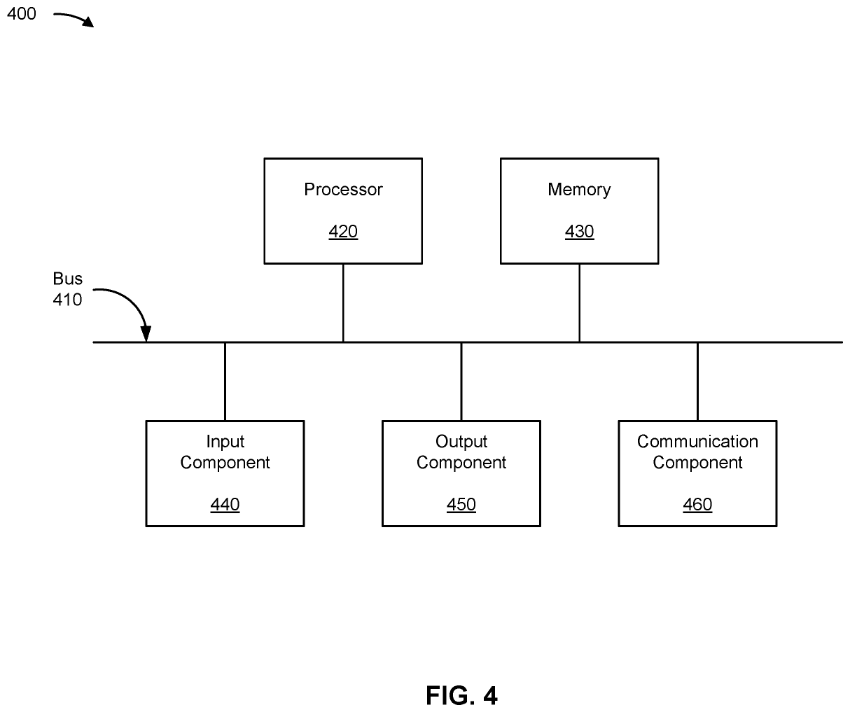

FIGS. 1A-1K are diagrams of an example 100 associated with text messages for interacting with integrated APIs. As shown in FIGS. 1A-1K, example 100 includes a unified interface system, a user device, a cellular network, an Internet network, a machine learning (ML) model (e.g., provided by an ML host), and an API function (e.g., provisioned by an API provider). These devices are described in more detail in connection with FIGS. 3 and 4.

As shown in FIG. 1A and by reference number 105, the user device may transmit, and the unified interface system may receive, a first text message that includes a first codeword. The first codeword may uniquely identify a first merchant or at least quasi-uniquely identify the first merchant (e.g., relative to a list of possible merchants associated with the unified interface system). As further shown by reference number 105, the user device may transmit, and the unified interface system may receive, the first text message over the cellular network. The cellular network may include a third generation (3G) network, a fourth generation (4G) network, a long term evolution (LTE) network, a fifth generation (5G) network, and/or another type of wireless network using over-the-air (OTA) communications. In some implementations, the cellular network may interface with a wired network (e.g., the Internet network and/or another type of wired network) to communicate with the unified interface system.

In some implementations, a user of the user device may provide input (e.g., using an input component of the user device) that triggers the user device to transmit the first text message. For example, the user device may output a user interface (UI) (e.g., using an output component of the user device), and the user may interact with the UI in order to provide the input that triggers the user device to transmit the first text message. In some implementations, the input may include content of the first text message. For example, the user may provide text to include in a body of the first text message.

The first text message may be addressed to a telephone number (e.g., a full telephone number or a short code used to address messages in a multimedia messaging system (MMS) and/or a short message service (SMS) system). Additionally, or alternatively, the first text message may be addressed to a username and/or an email address (e.g., when using an instant messaging service, such as iMessage® or WhatsApp®).

As shown by reference number 110, the unified interface system may identify the first codeword in the first text message. In some implementations, the unified interface system may identify the first codeword based on a leading character (e.g., at least one leading character) of the first codeword. For example, the unified interface system may identify codewords as starting with an at symbol (@), an ampersand (&), and/or another type of character. Additionally, or alternatively, the unified interface system may map the first codeword to an entry in a list of possible codewords. For example, the unified interface system may identify codewords as words (or phrases) that match an entry in the list. As used herein, “match” may refer to a perfect match (e.g., all characters in the entry appearing in the first text message in a same order as in the entry) or a fuzzy match (e.g., a perfect match except for case and/or punctuation, or a proportion of characters in the entry appearing in the first text message and the proportion satisfying a fuzzy match threshold, among other examples).

As shown in FIG. 1B, the unified interface system may transmit, and the user device may receive, an indication of a list of items associated with the first codeword. For example, as shown by reference number 115a, the unified interface system may transmit, and the user device may receive, a reply text message, indicating the list of items, via the cellular network. For example, the unified interface system may queue the reply text message, for transmission to the user device via the cellular network, in response to the first text message. Alternatively, as shown by reference number 115b, the unified interface system may transmit, and the user device may receive, a push notification, indicating the list of items, via the Internet network. For example, the user device may execute an app associated with the unified interface system, and an operating system (OS) of the user device may authorize the app to receive and output the push notification, in response to the first text message, in the background.

In some implementations, the indication of the list of items may include text encoding (at least a portion of) the list of items. Additionally, or alternatively, the indication may include a link (e.g., a hyperlink, such as a hypertext transfer protocol (HTTP) link) to the list of items. For example, the link may include a uniform resource locator (URL) that points to a webpage encoding the list of items and/or a file encoding the list of items (e.g., a portable document format (pdf) file and/or another type of file).

As shown in FIG. 1C, the user device may transmit, and the unified interface system may receive, an indication of one or more selected items from the list of items. For example, as shown by reference number 120a, the user device may transmit, and the unified interface system may receive, a follow-up text message, indicating the selected item(s), via the cellular network. For example, the user of the user device may provide input (e.g., using an input component of the user device) that triggers the user device to transmit the follow-up text message in response to the indication of the list of items. Alternatively, as shown by reference number 120b, the user device may transmit, and the unified interface system may receive, a message, indicating the selected items(s), via the Internet network. For example, the user may interact with the push notification (e.g., output by the app associated with the unified interface system), and the interaction may trigger the user device to transmit the indication of the selected item(s) in response to the indication of the list of items.

Although the example 100 is shown with the unified interface system providing the list of items in response to the first text message, other examples may include the first text message encoding the selected item(s) in addition to the first codeword. Additionally, or alternatively, the unified interface system may determine the selected item(s) using a setting associated with the user of the user device. For example, the setting may associate an identifier of the user (e.g., a telephone user, a username, and/or a name, among other examples) with a default set of items to use as the selected item(s). The setting may be stored locally (e.g., in a cache and/or another type of memory controlled by the unified interface) or at least partially separate (e.g., logically, physically, and/or virtually) from the unified interface system. In some implementations, the user device may transmit, and the unified interface system may receive and store, an indication of the setting.

As shown in FIG. 1D, the unified interface system may transmit, and the user device may receive, an indication of a list of payment methods (e.g., associated with the user of the user device). For example, as shown by reference number 125a, the unified interface system may transmit, and the user device may receive, a reply text message, indicating the list of payment methods, via the cellular network. For example, the unified interface system may queue the reply text message, for transmission to the user device via the cellular network, in response to the first text message and/or the indication of the selected item(s). Alternatively, as shown by reference number 125b, the unified interface system may transmit, and the user device may receive, a push notification, indicating the list of payment methods, via the Internet network. For example, the user device may execute an app associated with the unified interface system, and an OS of the user device may authorize the app to receive and output the push notification, in response to the first text message and/or the indication of the selected item(s), in the background.

In some implementations, the indication of the list of payment methods may include text encoding (at least a portion of) the list of payment methods. Additionally, or alternatively, the indication may include a link (e.g., a hyperlink, such as an HTTP link) to the list of payment methods. For example, the link may include a URL that points to a webpage encoding the list of payment methods.

As shown in FIG. 1E, the user device may transmit, and the unified interface system may receive, an indication of a selected payment method from the list of payment methods. For example, as shown by reference number 130a, the user device may transmit, and the unified interface system may receive, a follow-up text message, indicating the selected payment method, via the cellular network. For example, the user of the user device may provide input (e.g., using an input component of the user device) that triggers the user device to transmit the follow-up text message in response to the indication of the list of payment methods. Alternatively, as shown by reference number 130b, the user device may transmit, and the unified interface system may receive, a message, indicating the selected payment method, via the Internet network. For example, the user may interact with the push notification (e.g., output by the app associated with the unified interface system), and the interaction may trigger the user device to transmit the indication of the selected payment method in response to the indication of the list of payment methods.

Although the example 100 is shown with the unified interface system providing the list of payment methods in response to the first text message and/or the indication of the selected item(s), other examples may include the first text message indicating the selected payment method in addition to the first codeword. Additionally, or alternatively, the unified interface system may determine the selected payment method using a setting associated with the user of the user device. For example, the setting may associate an identifier of the user (e.g., a telephone user, a username, and/or a name, among other examples) with a default payment method to use as the selected payment method. The setting may be stored locally (e.g., in a cache and/or another type of memory controlled by the unified interface) or at least partially separate (e.g., logically, physically, and/or virtually) from the unified interface system. In some implementations, the user device may transmit, and the unified interface system may receive and store, an indication of the setting.

As shown in FIG. 1F and by reference number 135, the unified interface system may map the first codeword to a first API. For example, the unified interface system may use a data structure that associates codewords with APIs (e.g., with Internet protocol (IP) addresses indicating endpoints of the APIs and/or other types of identifiers of the APIs). The data structure may be stored in a local storage (e.g., a memory managed by the unified interface system) or in a storage that is at least partially separate (e.g., physically, logically, and/or virtually) from the unified interface system. Therefore, the unified interface system may transmit a query to the database (e.g., included in an HTTP request, included in a file transfer protocol (FTP) request, and/or using an API call) and receive a response to the query (e.g., included in an HTTP response, included in an FTP request, and/or as a return from the API call) that includes an identifier of the API.

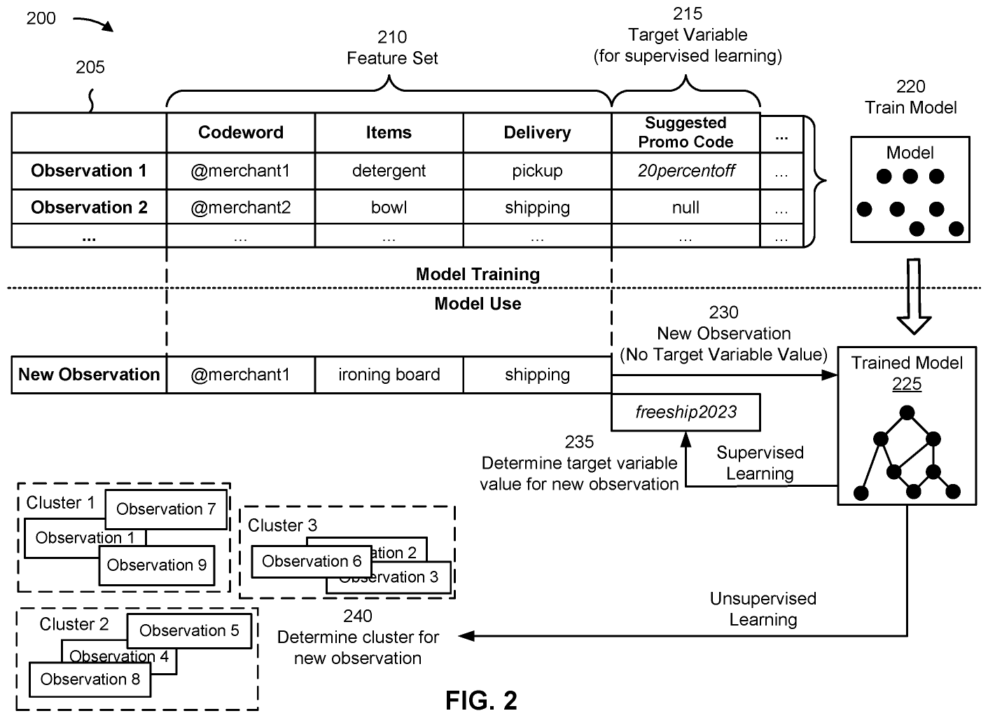

In some implementations, as shown by reference number 140, the unified interface system may provide (at least a portion of) the first text message to the ML model. For example, the unified interface system may transmit, and the ML host may receive, a request including the first text message. The ML model may be trained (e.g., by the ML host and/or a device at least partially separate from the ML host) using a labeled set of text messages (e.g., for supervised learning). The ML model may be configured to identify a promo code (e.g., from a list of possible promo codes) relevant to an order (e.g., triggered by a text message). Additionally, or alternatively, the ML model may be trained using an unlabeled set of text messages (e.g., for deep learning). The ML model may be configured to cluster text messages, such that a promo code may be identified as relevant to an order, triggered by a text message, based on a cluster in which the text message is classified. In some implementations, the ML model may be trained and applied as described in connection with FIG. 2. Although the example 100 is described in connection with the first text message being provided to the ML model, other examples may include an indication of the selected item(s) and/or an indication of the selected payment method being provided to the ML model in addition to, or in lieu of, the first text message.

As shown by reference number 145, the unified interface system may receive an indication of a suggested promo code from the ML model (e.g., from the ML host). For example, the ML model may output text encoding the suggested promo code. Additionally, or alternatively, the ML model may output a plurality of promo codes associated with a plurality of scores, where each score in the plurality of scores corresponds to a promo code in the plurality of promo codes (e.g., on a one-to-one basis). Therefore, the suggested promo code may be selected (e.g., by the ML model and/or the unified interface system) from the plurality of promo codes based on the plurality of scores (e.g., by selecting the promo code associated with a highest score). Additionally, or alternatively, the ML model may output a cluster indicator for the first text message. Therefore, the unified interface system may determine the suggested promo code by mapping the cluster indicator for the first text message to a promo code (e.g., based on a data structure mapping clusters to promo codes).

As shown in FIG. 1G, the unified interface system may transmit, and the user device may receive, an indication of the suggested promo code (e.g., received from the ML model). For example, as shown by reference number 150a, the unified interface system may output a reply text message, indicating the suggested promo code, via the cellular network. For example, the unified interface system may queue the reply text message, for transmission to the user device via the cellular network, in response to the first text message, the indication of the selected item(s), and/or the indication of the selected payment method. Alternatively, as shown by reference number 150b, the unified interface system may output a push notification, indicating the suggested promo code, via the Internet network. For example, the user device may execute an app associated with the unified interface system, and an OS of the user device may authorize the app to receive and output the push notification, in the background, in response to the first text message, the indication of the selected item(s), and/or the indication of the selected payment method.

In some implementations, the indication of the suggested promo code may include text encoding the suggested promo code. Additionally, or alternatively, the indication may include a link (e.g., a hyperlink, such as an HTTP link) to the suggested promo code. For example, the link may include a URL that points to a webpage encoding the suggested promo code.

As shown in FIG. 1H, the user device may transmit, and the unified interface system may receive, an acceptance of the suggested promo code. For example, as shown by reference number 155a, the user device may transmit, and the unified interface system may receive, an additional text message, including the acceptance, via the cellular network. For example, the user of the user device may provide input (e.g., using an input component of the user device) that triggers the user device to transmit the additional text message in response to the indication of the suggested promo code. Alternatively, as shown by reference number 155b, the user device may transmit, and the unified interface system may receive, a message, including the acceptance, via the Internet network. For example, the user may interact with the push notification (e.g., output by the app associated with the unified interface system), and the interaction may trigger the user device to transmit the acceptance in response to the indication of the suggested promo code.

Although the example 100 is described in connection with the acceptance, other examples may include the user device transmitting, and the unified interface system receiving, a rejection of the suggested promo code. For example, the user device may transmit, and the unified interface system may receive, an additional text message, including the rejection, via the cellular network. Alternatively, the user device may transmit, and the unified interface system may receive, a message, including the rejection, via the Internet network.

Although the example 100 is shown with the unified interface system providing the suggested promo code in response to the first text message, the indication of the selected item(s), and/or the indication of the selected payment method, other examples may include the unified interface system automatically using the suggested promo code (e.g., as described in connection with FIGS. 1I-1J). For example, a setting associated with the user of the user device may indicate that the user prefers promo codes to be automatically applied. The setting may be stored locally (e.g., in a cache and/or another type of memory controlled by the unified interface) or at least partially separate (e.g., logically, physically, and/or virtually) from the unified interface system. In some implementations, the user device may transmit, and the unified interface system may receive and store, an indication of the setting.

Although the example 100 is shown with the unified interface system using the ML model to determine the suggested promo code, other examples may include a third-party system that provides the suggested promo code to the unified interface system. For example, the third-party system may include Capital One® Shopping and/or another similar system. In some implementations, the unified interface system may transmit, and the third-party system may receive, a request including the first text message, an indication of the selected item(s), and/or an indication of the selected payment method. Accordingly, the third-party system may transmit, and the unified interface system may receive, an indication of the suggested promo code.

As shown in FIG. 1I and by reference number 160, the unified interface system may transmit, and the API function may receive, a first request. As further shown by reference number 160, the unified interface system may transmit, and the API function may receive, the first request via the Internet network. As described above, the unified interface system may identify the first API based on the first codeword; therefore, the first request may be transmitted to the first API (e.g., the “API function” shown in FIGS. 1I-1J may be the “first API”). The first API may be associated with the first merchant (e.g., because the first codeword is associated with both the first merchant and the first API). The first request may include information from the first text message. For example, the first request may include an identifier associated with the first merchant (e.g., a name and/or another type of identifier) and/or an identifier associated with the user of the user device (e.g., a username and/or another type of identifier). Additionally, or alternatively, the first request may include an indication of the selected item(s) (e.g., one or more names and/or item numbers) and/or an indication of the selected payment method (e.g., a name and/or a partial account number). In some implementations, the first request may further include the suggested promo code.

In some implementations, the first request may include a set of credentials (e.g., associated with an account, of the user, with the first merchant). The set of credentials may include a username and password, a single sign-on (SSO) request, a certificate, a private key, and/or biometric information, among other examples. Therefore, the first API may verify the set of credentials before receiving the first request. Alternatively, the unified interface system may transmit the set of credentials in a same message as the first request, and the first API may process the request in response to verifying the set of credentials. The set of credentials may be provided to the unified interface system by the user device (e.g., during a registration process). Accordingly, the user device may transmit, and the unified interface system may receive and store, the set of credentials.

As shown in FIG. 1J and by reference number 165, the API function may transmit, and the unified interface system may receive, a first confirmation of the first request. As further shown by reference number 165, the API function may transmit, and the unified interface system may receive, the first confirmation via the Internet network. The API function may transmit, and the unified interface system may receive, the first confirmation as a return from a call to the API function (e.g., the call being the first request described above).

In some implementations, the first confirmation may include information from the first text message. For example, the first confirmation may include an identifier associated with the first merchant (e.g., a name and/or another type of identifier) and/or an identifier associated with the user of the user device (e.g., a username and/or another type of identifier). Additionally, or alternatively, the first confirmation may include an indication of the selected item(s) that were successfully ordered and/or an indication of a successful charge to the selected payment method. In some implementations, the first confirmation may further indicate whether the suggested promo code was accepted. Additionally, or alternatively, the first confirmation may include tracking information (e.g., an indication of a carrier and/or a tracking number, among other examples) associated with a first order based on the first request.

As shown in FIG. 1K, the unified interface system may transmit, and the user device may receive, an indication of the first confirmation (e.g., received from the first API). For example, as shown by reference number 170a, the unified interface system may output an additional text message, indicating the first confirmation, via the cellular network. For example, the unified interface system may queue the additional text message, for transmission to the user device via the cellular network, in response to the first text message (and/or a follow-up text message, as described in connection with FIG. 1C, FIG. 1E, and/or FIG. 1H) from the user device. Alternatively, as shown by reference number 170b, the unified interface system may output a push notification, indicating the first confirmation, via the Internet network. For example, the user device may execute an app associated with the unified interface system, and an OS of the user device may authorize the app to receive and output the push notification, in the background, in response to the first text message (and/or a follow-up text message, as described in connection with FIG. 1C, FIG. 1E, and/or FIG. 1H).

In some implementations, the indication of the first confirmation may include text encoding information from the first confirmation (e.g., an indication of the selected item(s) that were successfully ordered, an indication of a successful charge to the selected payment method, an indication of whether the suggested promo code was accepted, and/or tracking information). Additionally, or alternatively, the indication may include a link (e.g., a hyperlink, such as an HTTP link) to the first confirmation. For example, the link may include a URL that points to a webpage encoding the first confirmation.

Although the example 100 is described in connection with the first confirmation, other examples may include the first API transmitting a first rejection in response to the first request. Accordingly, the unified interface system may transmit, and the user device may receive, an indication of the first rejection (e.g., received from the first API).

By allowing the user device to initiate requests to the first API using text messages, the unified interface system conserves power and processing resources at the user device. In particular, transmitting text messages uses less power and fewer processing resources at the user device as compared with the user device executing an app and/or accessing a website to communicate with the first API.

The operations described in connection with FIGS. 1A-1K are scalable across multiple merchants. For example, the user device may transmit, and the unified interface system may receive, a second text message that includes a second codeword. The second codeword may uniquely identify a second merchant or at least quasi-uniquely identify the second merchant (e.g., relative to a list of possible merchants associated with the unified interface system). Accordingly, the unified interface system may map the second codeword to a second API (e.g., provisioned by a same API provider or a different API provider), and the unified interface system may transmit, and the second API may receive, a second request (e.g., including information from the second request). Therefore, the second API may transmit, and the unified interface may receive, a second confirmation (or a second rejection), and the unified interface may output (e.g., to the user device) an indication of the second confirmation (or the second rejection).

By using techniques as described in connection with FIGS. 1A-1K, the unified interface system may communicate with the first API and the second API, which are associated with different merchants. Therefore, the user device may submit a first order to the first merchant and a second order to the second merchant using the unified interface system (e.g., via the first text message and the second text message). As a result, the user device reduces network overhead, latency, and memory overhead as compared with switching between apps and/or websites associated with the first and second merchants in order to submit the first and second orders, respectively. Additionally, the user device conserves power and processing resources that would otherwise have been spent on switching between the apps and/or websites.

In some implementations, the user device may further reduce network overhead and conserve power and processing resources by transmitting a text message that includes the first codeword and the second codeword. Accordingly, the unified interface system may transmit the first request to the first API and the second request to the second API based on a same text message from the user device.

As indicated above, FIGS. 1A-1K are provided as an example. Other examples may differ from what is described with regard to FIGS. 1A-1K.

FIG. 2 is a diagram illustrating an example 200 of training and using a machine learning model in connection with processing text messages for interacting with integrated APIs. The machine learning model training and usage described herein may be performed using a machine learning system. The machine learning system may include or may be included in a computing device, a server, a cloud computing environment, or the like, such as a unified interface system described in more detail elsewhere herein.

As shown by reference number 205, a machine learning model may be trained using a set of observations. The set of observations may be obtained from training data (e.g., historical data), such as data gathered during one or more processes described herein. In some implementations, the machine learning system may receive the set of observations (e.g., as input) from the unified interface system, as described elsewhere herein.

As shown by reference number 210, the set of observations may include a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the unified interface system. For example, the machine learning system may identify a feature set (e.g., one or more features and/or feature values) by extracting the feature set from structured data, by performing natural language processing to extract the feature set from unstructured data, and/or by receiving input from an operator.

As an example, a feature set for a set of observations may include a first feature of a codeword, a second feature of a selected item (or items), a third feature of a selected delivery means, and so on. As shown, for a first observation, the first feature may have a value of “@merchant1,” the second feature may have a value of “detergent,” the third feature may have a value of “pickup,” and so on. These features and feature values are provided as examples, and may differ in other examples. For example, the feature set may include one or more of the following features: a selected payment method, a selected location, user information, and/or a delivery address, among other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a target variable value, and a target variable value may be specific to an observation. In example 200, the target variable is a suggested promo code, which has a value of 20percentoff for the first observation.

The feature set and target variable described above are provided as examples, and other examples may differ from what is described above. The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. After training, the machine learning system may store the machine learning model as a trained machine learning model 225 to be used to analyze new observations.

As an example, the machine learning system may obtain training data for the set of observations based on text messages. For example, an administrator may label text messages received by the unified interface system with suggested promo codes in order to generate the set of observations for training. In another example, an administrator may label orders, associated with different codewords, with suggested promo codes in order to generate the set of observations for training.

As shown by reference number 230, the machine learning system may apply the trained machine learning model 225 to a new observation, such as by receiving a new observation and inputting the new observation to the trained machine learning model 225. As shown, the new observation may include a first feature of “@merchant1,” a second feature of “ironing board,” a third feature of “shipping,” and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 225 may predict a value of freeship2023 for the target variable of suggested promo code for the new observation, as shown by reference number 235. Based on this prediction, the machine learning system may provide a first recommendation, may provide output for determination of a first recommendation, may perform a first automated action, and/or may cause a first automated action to be performed (e.g., by instructing another device to perform the automated action), among other examples. The first recommendation may include, for example, using the suggested promo code. The first automated action may include, for example, including the suggested promo code in a request to an API function associated with a merchant that maps to the codeword (in the first feature).

As another example, if the machine learning system were to predict a value of null for the target variable of suggested promo code, then the machine learning system may provide a second (e.g., different) recommendation (e.g., using no promo code) and/or may perform or cause performance of a second (e.g., different) automated action (e.g., including no promo code in a request to an API function).

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., associated with a suggested promo code of freeship2023), then the machine learning system may provide a first recommendation, such as the first recommendation described above. Additionally, or alternatively, the machine learning system may perform a first automated action and/or may cause a first automated action to be performed (e.g., by instructing another device to perform the automated action) based on classifying the new observation in the first cluster, such as the first automated action described above.

As another example, if the machine learning system were to classify the new observation in a second cluster (e.g., associated with no suggested promo code), then the machine learning system may provide a second (e.g., different) recommendation, such as the second recommendation described above. Additionally, or alternatively, the machine learning system may perform a second automated action and/or may cause a second automated action to be performed, such as the second automated action described above.

In some implementations, the recommendation and/or the automated action associated with the new observation may be based on a target variable value having a particular label (e.g., classification or categorization), may be based on whether a target variable value satisfies one or more threshold (e.g., whether the target variable value is greater than a threshold, is less than a threshold, is equal to a threshold, falls within a range of threshold values, or the like), and/or may be based on a cluster in which the new observation is classified.

The recommendations, actions, and clusters described above are provided as examples, and other examples may differ from what is described above. In some implementations, the trained machine learning model 225 may be re-trained using feedback information. For example, feedback may be provided to the machine learning model. The feedback may be associated with actions performed based on the recommendations provided by the trained machine learning model 225 and/or automated actions performed, or caused, by the trained machine learning model 225. In other words, the recommendations and/or actions output by the trained machine learning model 225 may be used as inputs to re-train the machine learning model (e.g., a feedback loop may be used to train and/or update the machine learning model). For example, the feedback information may include acceptances and rejections of suggested promo codes (e.g., from a user device, as described in connection with FIG. 1H).

In this way, the machine learning system may apply a rigorous and automated process to generating suggested promo codes. The machine learning system may enable recognition and/or identification of tens, hundreds, thousands, or millions of features and/or feature values for tens, hundreds, thousands, or millions of observations, thereby increasing accuracy and consistency and reducing delay associated with identifying promo codes relative to searching for promo codes. For example, a user device and a search engine may conserve computing resources that would otherwise have been expended on queries to try to find promo codes. Additionally, network overhead is reduced that otherwise would have been increased by the queries.

As indicated above, FIG. 2 is provided as an example. Other examples may differ from what is described in connection with FIG. 2.

FIG. 3 is a diagram of an example environment 300 in which systems and/or methods described herein may be implemented. As shown in FIG. 3, environment 300 may include a unified interface system 301, which may include one or more elements of and/or may execute within a cloud computing system 302. The cloud computing system 302 may include one or more elements 303-312, as described in more detail below. As further shown in FIG. 3, environment 300 may include a network 320, a user device 330, an ML host 340, and/or an API provider 350. Devices and/or elements of environment 300 may interconnect via wired connections and/or wireless connections.

The cloud computing system 302 may include computing hardware 303, a resource management component 304, a host OS 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from computing hardware 303 of the single computing device. In this way, computing hardware 303 can operate more efficiently, with lower power consumption, higher reliability, higher availability, higher utilization, greater flexibility, and lower cost than using separate computing devices.

The computing hardware 303 may include hardware and corresponding resources from one or more computing devices. For example, computing hardware 303 may include hardware from a single computing device (e.g., a single server) or from multiple computing devices (e.g., multiple servers), such as multiple computing devices in one or more data centers. As shown, computing hardware 303 may include one or more processors 307, one or more memories 308, and/or one or more networking components 309. Examples of a processor, a memory, and a networking component (e.g., a communication component) are described elsewhere herein.

The resource management component 304 may include a virtualization application (e.g., executing on hardware, such as computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 310. Additionally, or alternatively, the resource management component 304 may include a container manager, such as when the virtual computing systems 306 are containers 311. In some implementations, the resource management component 304 executes within and/or in coordination with a host operating system 305.

A virtual computing system 306 may include a virtual environment that enables cloud-based execution of operations and/or processes described herein using computing hardware 303. As shown, a virtual computing system 306 may include a virtual machine 310, a container 311, or a hybrid environment 312 that includes a virtual machine and a container, among other examples. A virtual computing system 306 may execute one or more applications using a file system that includes binary files, software libraries, and/or other resources required to execute applications on a guest operating system (e.g., within the virtual computing system 306) or the host operating system 305.

Although the unified interface system 301 may include one or more elements 303-312 of the cloud computing system 302, may execute within the cloud computing system 302, and/or may be hosted within the cloud computing system 302, in some implementations, the unified interface system 301 may not be cloud-based (e.g., may be implemented outside of a cloud computing system) or may be partially cloud-based. For example, the unified interface system 301 may include one or more devices that are not part of the cloud computing system 302, such as device 400 of FIG. 4, which may include a standalone server or another type of computing device. The unified interface system 301 may perform one or more operations and/or processes described in more detail elsewhere herein.

The network 320 may include one or more wired and/or wireless networks. For example, the network 320 may include a cellular network, a public land mobile network (PLMN), a local area network (LAN), a wide area network (WAN), a private network, the Internet, and/or a combination of these or other types of networks. The network 320 enables communication among the devices of the environment 300. As described in connection with FIGS. 1A-1K, the network 320 may include a plurality of networks, such as a cellular network and an Internet network.

The user device 330 may include one or more devices capable of receiving, generating, storing, processing, and/or providing information associated with text messages, as described elsewhere herein. The user device 330 may include a communication device and/or a computing device. For example, the user device 330 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. The user device 330 may communicate with one or more other devices of environment 300, as described elsewhere herein.

The ML host 340 may include one or more devices capable of receiving, generating, storing, processing, and/or providing information associated with machine learning models, as described elsewhere herein. The ML host 340 may include a communication device and/or a computing device. For example, the ML host 340 may include a server, a database server, an application server, a client server, a web server, a host server, a proxy server, a virtual server (e.g., executing on computing hardware), a server in a cloud computing system, a device that includes computing hardware used in a cloud computing environment, or a similar type of device. The ML host 340 may communicate with one or more other devices of environment 300, as described elsewhere herein.

The API provider 350 may include one or more devices capable of receiving, generating, storing, processing, providing, and/or routing information from APIs (e.g., associated with merchants). The API provider 350 may include a communication device and/or a computing device. For example, the API provider 350 may include a server, such as an application server, a client server, a web server, a database server, a host server, a proxy server, a virtual server (e.g., executing on computing hardware), or a server in a cloud computing system. In some implementations, the API provider 350 may include computing hardware used in a cloud computing environment. The API provider 350 may communicate with one or more other devices of environment 300, as described elsewhere herein.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400 associated with sending and processing text messages for interacting with integrated APIs. The device 400 may correspond to a user device 330, an ML host 340, and/or an API provider 350. In some implementations, a user device 330, an ML host 340, and/or an API provider 350 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

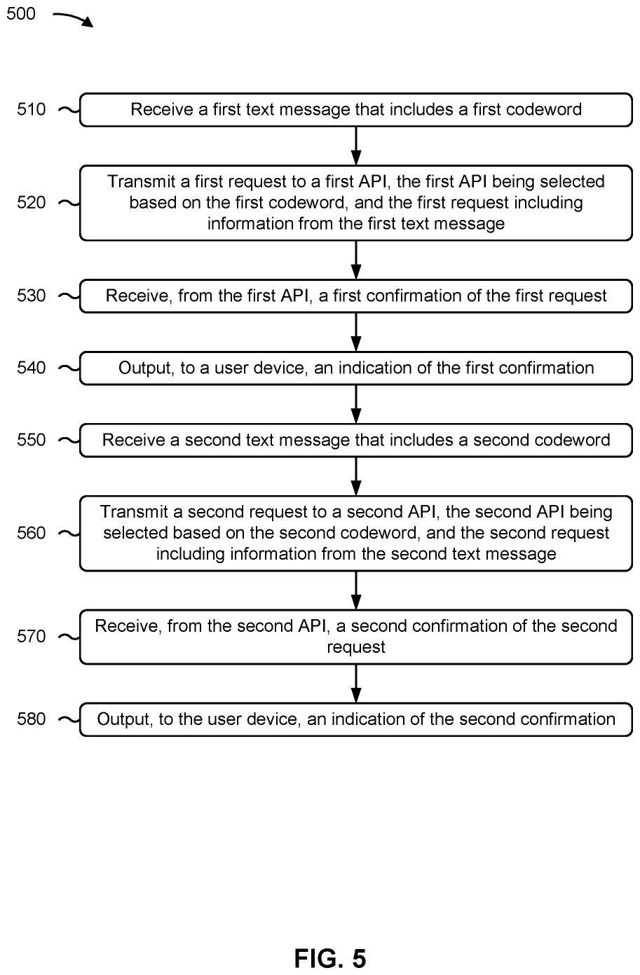

FIG. 5 is a flowchart of an example process 500 associated with processing text messages for interacting with integrated APIs. In some implementations, one or more process blocks of FIG. 5 may be performed by a unified interface system 301. In some implementations, one or more process blocks of FIG. 5 may be performed by another device or a group of devices separate from or including the unified interface system 301, such as a user device 330, an ML host 340, and/or an API provider 350. Additionally, or alternatively, one or more process blocks of FIG. 5 may be performed by one or more components of the device 400, such as processor 420, memory 430, input component 440, output component 450, and/or communication component 460.

As shown in FIG. 5, process 500 may include receiving a first text message that includes a first codeword (block 510). For example, the unified interface system 301 (e.g., using processor 420, memory 430, and/or communication component 460) may receive a first text message that includes a first codeword, as described above in connection with reference number 105 of FIG. 1A. As an example, the unified interface system 301 may receive the first text message over a cellular network. The first codeword may uniquely identify a first merchant or at least quasi-uniquely identify the first merchant (e.g., relative to a list of possible merchants associated with the unified interface system 301).

As further shown in FIG. 5, process 500 may include transmitting a first request to a first API, the first API being selected based on the first codeword, and the first request including information from the first text message (block 520). For example, the unified interface system 301 (e.g., using processor 420, memory 430, and/or communication component 460) may transmit a first request to a first API, the first API being selected based on the first codeword, and the first request including information from the first text message, as described above in connection with reference number 160 of FIG. 1I. As an example, the unified interface system 301 may identify the first API by using a data structure that associates codewords with APIs (e.g., with IP addresses indicating endpoints of the APIs and/or other types of identifiers of the APIs). The first request may include an identifier associated with the first merchant (e.g., a name and/or another type of identifier), an identifier associated with a user of the user device (e.g., a username and/or another type of identifier), an indication of one or more items (e.g., one or more names and/or item numbers), and/or an indication of a selected payment method (e.g., a name and/or a partial account number).

As further shown in FIG. 5, process 500 may include receiving, from the first API, a first confirmation of the first request (block 530). For example, the unified interface system 301 (e.g., using processor 420, memory 430, and/or communication component 460) may receive, from the first API, a first confirmation of the first request, as described above in connection with reference number 165 of FIG. 1J. As an example, the unified interface system 301 may receive the first confirmation as a return from a call to the first API (e.g., the call being the first request described above).

As further shown in FIG. 5, process 500 may include outputting, to a user device, an indication of the first confirmation (block 540). For example, the unified interface system 301 (e.g., using processor 420, memory 430, and/or communication component 460) may output, to a user device, an indication of the first confirmation, as described above in connection with reference number 170a or 170b of FIG. 1K. As an example, the unified interface system 301 may output an additional text message, indicating the first confirmation, via a cellular network. Alternatively, the unified interface system 301 may output a push notification, indicating the first confirmation, via an Internet network.

As further shown in FIG. 5, process 500 may include receiving a second text message that includes a second codeword (block 550). For example, the unified interface system 301 (e.g., using processor 420, memory 430, and/or communication component 460) may receive a second text message that includes a second codeword, as described above in connection with FIGS. 1A-1K. As an example, the unified interface system 301 may receive the second text message over a cellular network. The second codeword may uniquely identify a second merchant or at least quasi-uniquely identify the second merchant (e.g., relative to a list of possible merchants associated with the unified interface system 301).

As further shown in FIG. 5, process 500 may include transmitting a second request to a second API, the second API being selected based on the second codeword, and the second request including information from the second text message (block 560). For example, the unified interface system 301 (e.g., using processor 420, memory 430, and/or communication component 460) may transmit a second request to a second API, the second API being selected based on the second codeword, and the second request including information from the second text message, as described above in connection with FIGS. 1A-1K. As an example, the unified interface system 301 may identify the second API by using a data structure that associates codewords with APIs (e.g., with IP addresses indicating endpoints of the APIs and/or other types of identifiers of the APIs). The second request may include an identifier associated with the second merchant (e.g., a name and/or another type of identifier), an identifier associated with a user of the user device (e.g., a username and/or another type of identifier), an indication of one or more items (e.g., one or more names and/or item numbers), and/or an indication of a selected payment method (e.g., a name and/or a partial account number).

As further shown in FIG. 5, process 500 may include receiving, from the second API, a second confirmation of the second request (block 570). For example, the unified interface system 301 (e.g., using processor 420, memory 430, and/or communication component 460) may receive, from the second API, a second confirmation of the second request, as described above in connection with FIGS. 1A-1K. As an example, the unified interface system 301 may receive the second confirmation as a return from a call to the second API (e.g., the call being the second request described above).

As further shown in FIG. 5, process 500 may include outputting, to the user device, an indication of the second confirmation (block 580). For example, the unified interface system 301 (e.g., using processor 420, memory 430, and/or communication component 460) may output, to the user device, an indication of the second confirmation, as described above in connection with FIGS. 1A-1K. As an example, the unified interface system 301 may output an additional text message, indicating the second confirmation, via a cellular network. Alternatively, the unified interface system 301 may output a push notification, indicating the second confirmation, via an Internet network.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1K and/or FIG. 2. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

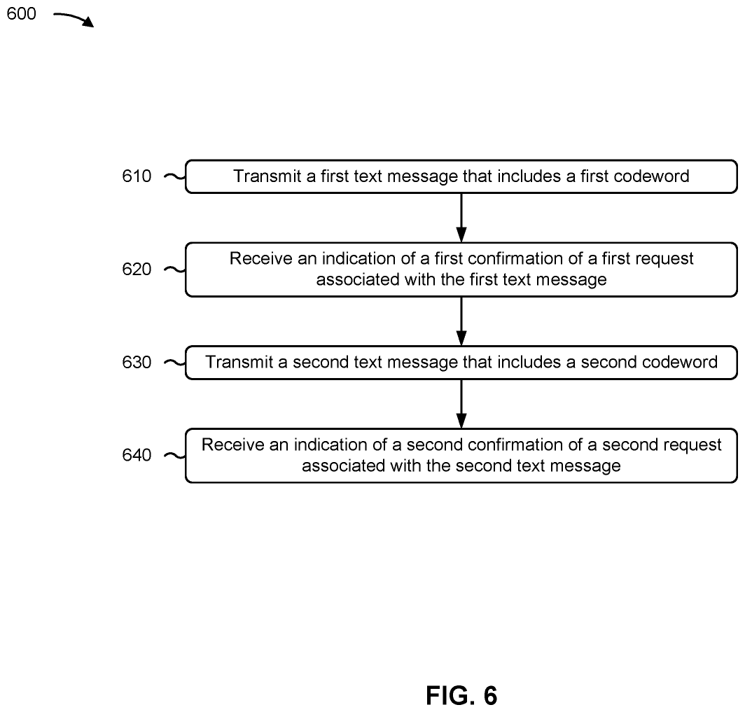

FIG. 6 is a flowchart of an example process 600 associated with sending text messages for interacting with integrated APIs. In some implementations, one or more process blocks of FIG. 6 may be performed by a user device 330. In some implementations, one or more process blocks of FIG. 6 may be performed by another device or a group of devices separate from or including the user device 330, such as a unified interface system 301, an ML host 340, and/or an API provider 350. Additionally, or alternatively, one or more process blocks of FIG. 6 may be performed by one or more components of the device 400, such as processor 420, memory 430, input component 440, output component 450, and/or communication component 460.

As shown in FIG. 6, process 600 may include transmitting a first text message that includes a first codeword (block 610). For example, the user device 330 (e.g., using processor 420, memory 430, and/or communication component 460) may transmit a first text message that includes a first codeword, as described above in connection with reference number 105 of FIG. 1A. As an example, a user of the user device 330 may provide input (e.g., using an input component 440 of the user device 330) that triggers the user device to transmit the first text message. In some implementations, the input may include content of the first text message. For example, the user may provide text to include in a body of the first text message.

As further shown in FIG. 6, process 600 may include receiving an indication of a first confirmation of a first request associated with the first text message (block 620). For example, the user device 330 (e.g., using processor 420, memory 430, and/or communication component 460) may receive an indication of a first confirmation of a first request associated with the first text message, as described above in connection with reference number 170a or 170b of FIG. 1K. As an example, the user device 330 may receive an additional text message, indicating the first confirmation, via a cellular network. Alternatively, the user device 330 may receive a push notification, indicating the first confirmation, via an Internet network.

As further shown in FIG. 6, process 600 may include transmitting a second text message that includes a second codeword (block 630). For example, the user device 330 (e.g., using processor 420, memory 430, and/or communication component 460) may transmit a second text message that includes a second codeword, as described above in connection with FIGS. 1A-1K. As an example, a user of the user device 330 may provide input (e.g., using an input component 440 of the user device 330) that triggers the user device to transmit the second text message. In some implementations, the input may include content of the second text message. For example, the user may provide text to include in a body of the second text message.

As further shown in FIG. 6, process 600 may include receiving an indication of a second confirmation of a second request associated with the second text message (block 640). For example, the user device 330 (e.g., using processor 420, memory 430, and/or communication component 460) may receive an indication of a second confirmation of a second request associated with the second text message, as described above in connection with FIGS. 1A-1K. As an example, the user device 330 may receive an additional text message, indicating the second confirmation, via a cellular network. Alternatively, the user device 330 may receive a push notification, indicating the second confirmation, via an Internet network.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel. The process 600 is an example of one process that may be performed by one or more devices described herein. These one or more devices may perform one or more other processes based on operations described herein, such as the operations described in connection with FIGS. 1A-1K and/or FIG. 2. Moreover, while the process 600 has been described in relation to the devices and components of the preceding figures, the process 600 can be performed using alternative, additional, or fewer devices and/or components. Thus, the process 600 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for using text messages with integrated application programming interfaces (APIs), the system comprising:
one or more memories; and
one or more processors, communicatively coupled to the one or more memories, configured to:
receive a first text message that includes a first codeword;
transmit a first request to a first API, wherein the first API is selected based on the first codeword, and the first request includes information from the first text message;
receive, from the first API, a first confirmation of the first request;
output, to a user device, an indication of the first confirmation;
provide at least a portion of the first text message to a machine learning model in order to receive a suggested promo code;
output, to the user device, an indication of the suggested promo code;
receive a second text message that includes a second codeword;
transmit a second request to a second API, wherein the second API is selected based on the second codeword, and the second request includes information from the second text message;
receive, from the second API, a second confirmation of the second request; and
output, to the user device, an indication of the second confirmation.

2. The system of claim 1, wherein the one or more processors are configured to:
receive an acceptance of the suggested promo code,
wherein the first request further includes the suggested promo code.

3. The system of claim 2, wherein the first confirmation indicates whether the suggested promo code was accepted.

4. The system of claim 2, wherein the acceptance is included in an additional text message.

5. The system of claim 2, wherein the acceptance comprises an interaction with a push notification.

6. The system of claim 1, wherein the indication of the first confirmation is included in an additional text message.

7. The system of claim 1, wherein the indication of the first confirmation is included in a push notification.

8. A method of using text messages with integrated application programming interfaces (APIs), comprising:
transmitting, from a user device, a first text message that includes a first codeword;
receiving, at the user device, an indication of a first confirmation of a first request associated with the first text message;
transmitting, from the user device, a second text message that includes a second codeword; and
receiving, at the user device, an indication of a second confirmation of a second request associated with the second text message.

9. The method of claim 8, further comprising:
receiving, at the user device, an indication of a suggested promo code associated with the first request; and
transmitting, from the user device, an acceptance of the suggested promo code.

10. The method of claim 9, wherein the indication of the first confirmation of the first request indicates whether the suggested promo code was accepted.

11. The method of claim 8, wherein the first text message and the second text message are transmitted over a cellular network.

12. The method of claim 8, wherein the indication of the first confirmation and the indication of the second confirmation are received in additional text messages.

13. The method of claim 8, wherein the indication of the first confirmation and the indication of the second confirmation are received as push notifications.

14. The method of claim 8, further comprising:
receiving, in response to the first text message, a reply text message indicating a list of items associated with the first codeword; and
transmitting, in response to the reply text message, a follow-up text message indicating at least one item from the list of items,
wherein the indication of the first confirmation is received in response to the follow-up text message.

15. A non-transitory computer-readable medium storing a set of instructions for using text messages with integrated application programming interfaces (APIs), the set of instructions comprising:
one or more instructions that, when executed by one or more processors of a device, cause the device to:
receive a first text message that includes a first codeword;
transmit a first request to a first API, wherein the first API is selected based on the first codeword, and the first request includes information from the first text message;
receive, from the first API, a first confirmation of the first request;
output, to a user device, an indication of the first confirmation;
receive a second text message that includes a second codeword;
transmit a second request to a second API, wherein the second API is selected based on the second codeword, and the second request includes information from the second text message;
receive, from the second API, a second confirmation of the second request; and
output, to the user device, an indication of the second confirmation.

16. The non-transitory computer-readable medium of claim 15, wherein the one or more instructions, when executed by the one or more processors, cause the device to:
identify the first codeword based on at least one leading character of the first codeword.

17. The non-transitory computer-readable medium of claim 15, wherein the one or more instructions, when executed by the one or more processors, cause the device to:
map the second codeword to the second API using a data structure that associates codewords with APIs.

18. The non-transitory computer-readable medium of claim 15, wherein the one or more instructions, when executed by the one or more processors, cause the device to:
transmit, in response to the first text message, a reply text message indicating a list of items associated with the first codeword; and
receive, in response to the reply text message, a follow-up text message indicating at least one item from the list of items,
wherein the first request indicates the at least one item.

19. The non-transitory computer-readable medium of claim 15, wherein the one or more instructions, when executed by the one or more processors, cause the device to:
transmit, in response to the first text message, a reply text message indicating a list of payment methods; and
receive, in response to the reply text message, a follow-up text message indicating a selected payment method from the list of payment methods,
wherein the first request indicates the selected payment method.

20. The non-transitory computer-readable medium of claim 15, wherein the indication of the first confirmation includes tracking information associated with a first order based on the first request.
